(19) United States
(12) Patent Application Publication
(10) Pub. No.: US 2005/0112232 A1
(43) Pub. Date: May 26, 2005

(54) Animal feed supplement

(76) Inventors: Jean-Marie Dollat, Montlucon (FR); Jean-Claude Robert, Neris Les Bains (FR); Veronique Chiavazza, Caluire (FR)

Correspondence Address: OLIFF & BERRIDGE, PLC, P.O. BOX 19928, ALEXANDRIA, VA, 22320, US

(21) Appl. No.: 10/507,070

(22) PCT Filed: Apr. 28, 2003
(86) PCT No.: PCT/IB03/01726

(30) Foreign Application Priority Data
Apr. 30, 2002 (EP) 02356081.6

(51) Int. Cl. A01K 1/00

(52) U.S. Cl. 426/2

(57) ABSTRACT

An animal rumen-resistant feed supplement in the solid form, said feed supplement comprising at least one methionine derivative and a porous carrier material wherein (a) said methionine derivative is selected from the group consisting of liquid and solid esters of the 2-hydroxy-4-(methylthio)butanoic acid, with the proviso that solid esters have a melting point of 100° C. at most; the 2-amino-4-methylthiobutanamide and the 2-hydroxy-4-methylthiobutanamide, (b) said methionine derivative accounts for at least 20% and up to 70% by weight of the feed supplement and (c) said supplement is in the form of particles having a size range of from 80 to 600 microns.

The present invention relates to a novel animal feed supplement.

Methionine is a well known additive for animal feed, in particular for ruminants. Methionine may be added directly to the animal feed. The free form of this compound however is degraded rapidly by bacteria in the rumen and consequently only a small portion of the original methioinine is able to enter the bloodstream. An analogue of methionine is also often used, namely the hydroxy analogue having the chemical name 2-hydroxy-4-(methylthio)butanoic acid, generally referred to as HMB. This product is used in the liquid form and is also largely degraded in the rumen.

A commercially known product sold as Smartamine sold by Aventis Animal Nutrition is effective in providing methionine to the animal and tests have shown that the methionine enters the blood stream in 10 hours after administration. Recent research has also shown that certain esters of methionine or HMB (2-hydroxy-4(methylthio)butanoic acid) may also be successfully used to provide the necessary bio-available methionine to ruminants. WO-00/28835 discloses the use of the ester form of the hydroxy analogue and in particular this document teaches that at least 50% of bio-available methionine may be provided through the administration of the isopropyl ester of the hydroxy analogue of methionine.

We have now found that when some methionine derivatives, and in particular the isopropyl ester of the hydroxy analogue of methionine, is provided in the solid form and admixed with the animal feed, the product shows good bioavalable results at least equivalent to the liquid form.

Accordingly, the present invention provides an animal rumen-resistant feed supplement in the solid form said feed supplement comprising at least one methionine derivative and a porous carrier material, wherein (a) said methionine derivative is selected from the group consisting of liquid and solid esters of the 2-hydroxy-4-(methylthio)butanoic acid, with the proviso that solid esters have a melting point of 100° C. at most; the 2-amino-4-methylthiobutanamide and the 2-hydroxy-4-methylthiobutanamide, (b) said methionine derivative accounts for at least 20% and up to 70% by weight of the feed supplement and (c) said supplement is in the form of particles having a size range of from 80 to 600 microns.

The present invention provides the advantage over the previously known animal feed supplements in that the use of the particular feed supplement not only provides a large amount of methionine to the animal but that methionine is found to be present in the bloodstream after a short period of time when compared to the commercially available methionine sources.

The present invention provides an animal feed supplement that is in the solid form. For the purposes of the present invention solid form is defined as powder wherein the particles or granules of powder have a size range of from 80 to 600 microns, preferably 125 to 500 microns and more preferably 160 to 400 microns.

The feed supplement of the present invention comprises a methionine derivative which may be selected from linear and branched alkyl esters of the 2-hydroxy-4-(methylthio)butanoic acid. Suitable esters include methyl ester, ethyl ester, n-propyl ester, isopropyl ester, butyl esters, namely n-butyl ester, sec butyl ester, isobutyl ester and tertio butyl ester, pentyl esters and hexyl esters, especially n-pentyl, isopentyl, n-hexyl and isohexyl esters.

Preferably, the ester is a branched alkyl ester, especially the isopropyl ester and the tertio butyl ester. In particular, it has been found that a solid feed supplement comprising the isopropyl ester of the hydroxy analogue of methionine displays a bio-availability of methionine of more than 50%.

The methionine derivative accounts for at least 20% and up to 70% by weight of the total feed composition. Suitably, this compound is present in an amount of from 20 to 70% by weight.

The feed supplement of the present invention comprises a porous carrier material. Suitably the carrier material has a porosity of at least 0.4 ml/g, and preferably at least 1.5 ml/g. Suitable carrier materials include natural clays and silicates such as vermiculite, sepiolite, perlite, bentonite, and/or zeolithes and/or porous silica. One preferred material is a clay, especially sepiolite, commercially available as Exal-H; in this case, the methionine derivative accounts up to 40% by weight of the feed supplement. Another preferred material is silica and the methionine derivative accounts up to 70% by weight of the feed supplement.

The granule may comprise additional components such as an anti-caking agent, an anti-oxidising agent and a surfactant. Anti-caking agents suitable for use in the present invention include silica, talcum, calcium phosphate, calcium carbonate and magnesium stearate. The preferred anti-caking agent is a compound having a high surface area, for example at least 100 m²/g. Preferably, the anti-caking agent is silica. The ant-caking agent is suitable present in an amount of from 0 to 2% by weight.

As regards the anti-oxidising agent, suitable agents include tocopherol, ascorbic acid, ethoxyquine, propyl, octyl or dodecyl gallate, butyl hydroxy anisole (commonly referred to as BHA) and butylated hydroxytoluene (commonly referred to as BHT). The anti-oxidant may be present in the solid in an amount of from 0 to 3% by weight of the granule.

Surfactants suitable for use in the present invention include sulphates such as sodium alkyl sulphate or lauryl sulphate, polysorbates such as polyoxy ethylene sorbitol fatty acid esters. The surfactant is present in an amount of from 0 to 5% by weight.

The granule may contain water although it is preferred that the granule is essentially dry. The water content may be from 0 to 10% by weight.

A particularly preferred granule of the present invention comprises 25 to 30% by weight of the isopropyl ester of the hydroxy analogue of methionine, and 75 to 70% of sepiolite.

The solid particle may suitably have an average medium diameter of from 200 to 400 microns, preferably from 275 to 325 microns and a bulk density suitably of from 700 to 950 kg/m³, preferably from 800 to 900 kg/m³.

The feed supplement of the present invention may be prepared by impregnation of the carrier material with the liquid methionine containing product optionally followed by addition of the ant-caking agent. This procedure may be carried out by mixing the components using any suitable blender or mixer. The mixing may be carried out at a temperature of from 20 to 80° C., preferably from 40 to 70° C. The speed of mixing will be determined by the desired size of the resulting powder. Alternatively, the mixing may be carried out in a fluidised bed.

The feed supplement of the present invention may be incorporated into the food of the animal and according to another aspect of the present invention there is provided an animal feed comprising a feed supplement as herein before defined.

The present invention will now be described in detail with reference to the following examples:

In the following preparative work, the following standard tests were carried out on the solid supplement:

1. Particle Size: The size of the solid particle was determined by passing 100 g of the granules through Retsch sieves with 1.5 mm of amplitude during a period of 10 minutes.

2. Bulk and Tapped Density: The bulk and tapped density were determined by powder volumenometer (230 ml).

3. Carr Index—This index is defined as:
(Bulk Density−Tapped Density)/Bulk Density

4. Flow Index: The flow Index was determined by a flow tester which is the ring shear stress of Schulze (device reference RST-01.01 Dr Ing. Dietmar Schulze, Wolfenbuttel, Germany). Jenike Index is defined by the ratio of principal stress at a steady flow to the unconfined yield strength.

### EXAMPLE 1

### Preparation of Feed Supplement Containing the Isopropyl Ester of 2-Hydroxy-4-(Methylthio)butanoic Acid (HMBI Supported on Sepiolite Clay)

A weight of 0.22 kg of sepiolite clay (70 weight %) was placed in an Aeromatic fluidized bed. Gas was allowed to flow through the bed. The clay was suspended in the gas flow for 5 minutes. 0.11 kg of liquid isopropyl ester of 2-hydroxy-4-(methylthio)butanoic acid (30 weight %) was sprayed through a nozzle positioned at the top of the bed. The spraying procedure was allowed to continue for 10 minutes. Fluidisation of the bed was allowed to continue for a further five minutes thereafter. The gas flow was ten discontinued.

320 g of powdered product was collected and divided by a Retsch device into 8 portions of 40 g. Each portion was then divided into 8 further portions of 5 g for stability measurement.

The stability of the solid product was determined by measuring the amount of HMBI in the solid product after production (0 days) and after 15, 45 and 90 days The solid material was kept under ambient conditions throughout the test period. The level of HMBI remained constant throughout the test period indicating good stability of the feed supplement. The results are given in Table 1.

TABLE 1

| Amount | Batch |
|---|---|
| HMBI (theoretical) | 30.7% |
| HMBI (0 days) | 31.0% |
| HMBI (15 days) | 29.8% |
| HMBI (45 days) | 31.2% |
| HMBI (90 days) | 31.4% |

### EXAMPLE 2

### Preparation of Feed Supplement Containing the Isopropyl Ester of 2-Hydroxy-4-(Methylthio)butanoic Acid (HMBI Supported on Sepiolite Clay)

A weight of 35 kg of sepiolite clay (70 weight %) was placed in a 130 litres Lodgie plow mixer. The clay was stirred for five minutes. 11.6 kg of the liquid isopropyl ester of 2-hydroxy-4-(methylthio)butanoic acid (30 weight %) was poured into the mixer at a flow rate of 36 kg/hour. The resulting mixture was homogenised for 20 minutes.

The size, the bulked and tapped density, Carr Index and Flow Index of the resulting granules were determined according to the aforementioned procedures. The results are given in Table 2.

### EXAMPLE 3

### Preparation of Feed Supplement Containing the Isopropyl Ester of 2-Hydroxy-4-(Methylthio)butanoic Acid (HMBI Supported on Sepiolite Clay)

A weight of 27 kg of sepiolite clay (70 weight %) was placed in a 130 litres Lodgie plow mixer. The clay was stirred for five minutes. 15 kg of the liquid isopropyl ester of 2-hydroxy-4-(methylthio)butanoic acid (30 weight %) was heated to 60° C. an then poured into the mixer at a flow rate of 35 kg/hour. The resulting mixture was homogenised for 20 minutes.

The size, the bulked and tapped density, Carr Index and Flow Index of the resulting granules were determined according to the aforementioned procedures. The results are given in Table 2.

TABLE 2
physical properties of the products resulting from Examples 2 and 3

| Characteristic of powder | Example 2 | Example 3 |
|---|---|---|
| HMBI expected theoretical amount* | 27.6 | 27.6 |
| HMBI amount measured | 28.4 | 27.7 |
| Size distribution | sieve* | sieve* |
| D₁₀ (μm) | 167 | 135 |
| D₅₀ (μm) | 344 | 310 |
| D₉₀ (μm) | 529 | 504 |
| % > 630 μm | 1.6 | 2.1 |
| % < 100 μm | 1.9 | 1.7 |
| Porosity | | |
| Total porous volume (cm³/g) | 0.38 | 0.41 |
| Residual intraparticular porous | 0.09 | 0.11 |
| volume (cm³/g) | | |
| Diameter of interparticular pores | 67 | 74 |
| (μm) | | |
| Calculated particle density** (g/cm³) | 1.44 | 1.42 |
| Bulk powder density (g/cm³) | 0.89 | 0.91 |
| Tapped powder density (g/cm³) | 0.95 | 0.98 |
| Carr index | 7% | 8% |
| Flowing index (annular cell) | 20 | 19 |

*Taking into account the purity of HMBI of 92%
**Calculated from specific gravity of the sepiolite and specific gravity of the liquid

### EXAMPLE 4

A weight of 0.5 kg of silica Tixosil 68 from Rhodia supplier was placed in a 5 liters Lodige plow mixer. The silica was stirred for two minutes at 200 rpm. Then, 0.5 kg of liquid isopropyl ester of 2-hydroxy-4-(methylthio)butanoic acid (50% weight) was poured into the mixer at a flow rate of 3.6 kg/hour. The mixture was homogenised for 20 minutes.

The size, the bulk and tapped density, carr Index and flow index of the resulting granules were determined according the aforementioned procedures and given in table 3. The stability of such a powder is good because the amount of HMBI remained constant after one month.

### EXAMPLE 5

A weight of 0.5 kg of silica Tixosil 68 from Rhodia supplier was placed in a 5 liters Lodige plow mixer. The silica was stirred for two minutes at 200 rpm. Then, 0.7 kg of liquid isopropyl ester of 2-hydroxy-4-(methylthio)butanoic acid (58.3% weight) was poured into the mixer at a flow rate of 3.4 kg/hour. The mixture was homogenised for 20 minutes.

The size, the bulk and tapped density, carr Index and flow index of the resulting granules were determined according the aforementioned procedures and given in table 3. The stability of such a powder is good because the amount of HMBI remained constant after one month.

### EXAMPLE 6

A weight of 0.5 kg of silica Tixosil 68 from Rhodia supplier was placed in a 5 liters Lodige plow mixer. The silica was stirred for two minutes at 200 rpm. Then, 0.9 kg of liquid isopropyl ester of 2-hydroxy-4-(methylthio)butanoic acid (65% weight) was poured into the mixer at a flow rate of 3.4 kg/hour. The mixture was homogenised for 20 minutes.

The size, the bulk and tapped density, carr Index and flow index of the resulting granules were determined according the aforementioned procedures and given in table 3. The stability of such a powder is good because the amount of HMBI remained constant after one month.

### EXAMPLE 7

A weight of 14 kg of silica Tixosil 68 from Rhodia supplier was placed in a 130 liters Lodige plow mixer. The silica was stirred for two minutes at 270 rpm. Then, 26 kg of liquid isopropyl ester of 2-hydroxy-4-(methylthio)butanoic acid (64.9% weight) was poured into the mixer at a flow rate of 39 kg/hour. The mixture was homogenised for 10 minutes and the chopper was turned on for one minute.

The size, the bulk and tapped density, Carr Index and flow index of the resulting granules were determined according the aforementioned procedures and given in table 3.

TABLE 3
physical properties of products resulting from Examples 4, 5, 6 and 7

| | Exam- | Exam- | Exam- | Exam- |
|---|---|---|---|---|
| Characteristic of powder | ple 4 | ple 5 | ple 6 | ple7 |
| HMBI expected theoretical amount | 47 | 54.8% | 61.1% | 61% |
| HMBI amount measured by HPLC | 46.4 | 56.5% | 60.8% | 61.4% |
| HMBI amount measured by HPLC | 47.8 | 56.3% | 62% | |
| after storage of powder one | | | | |
| month at 40° C. | | | | |
| Size distribution | sieve* | | | |
| D₁₀ (μm) | 140 | 140 | 150 | 140 |
| D₅₀ (μm) | 280 | 280 | 290 | 310 |
| D₉₀ (μm) | 390 | 390 | 400 | 370 |
| % > 500 μm | 1.2 | 1.3 | 2 | 0.2 |
| % < 80 μm | 0 | 0 | 0 | 0.6 |
| Calculated particle density** | 1.40 | 1.33 | 1.27 | 1.27 |
| (g/cm³) | | | | |
| Bulk powder density (g/cm³) | 0.51 | 0.64 | 0.70 | 0.64 |
| Tapped powder density (g/cm³) | 0.58 | 0.72 | 0.76 | 0.73 |
| Carr index | 14% | 11% | 9% | 14% |
| Flowing index (annular cell) | 20 | 20 | 20 | 17 |

*Taking into account the purity of HMBI = 94%

### EXAMPLE 8

### Bio-Availability Tests

The solid feed supplement containing HMBI prepared according to Example 1 above comprising 30% HMBI and 70% sepiolite clay was added to a feed ration and given to 4 dry cows over a period of 7 days at two different daily doses. A similar study was carried out using liquid HMBI (Comparative Example 1) and the commercially known product Smartamine (Solid form—Comparative Example 2). The amount of feed supplement in each case was calculated to provide 50 g of either methionine-equivalent (HMB), in the case of the solid and liquid powdered HMBI or methionine in the case of Smartamine.

The feed supplement was introduced into the normal feed ration once per day. Blood samples were taken every half hour for the first two hours following administration of the feed and then every two hours thereafter for the Example 1 and Comparative Example 1 and every two hours in Comparative Example 2.

The concentration of methionine in the blood was measured and plotted. The area under the curve was calculated to give the bio-availability results. The feed supplement according to the present invention provided 56% bio-available methionine. The liquid HMBI feed supplement provided 49% bio-available methionine. Smartamine provided 82% bio-available methionine. The liquid and solid HMBI feed supplements resulted in methionine absorption into the bloodstream within 2 hours after intake whilst for Smartamine, methionine was detected after 10 hours resulted in methionine.

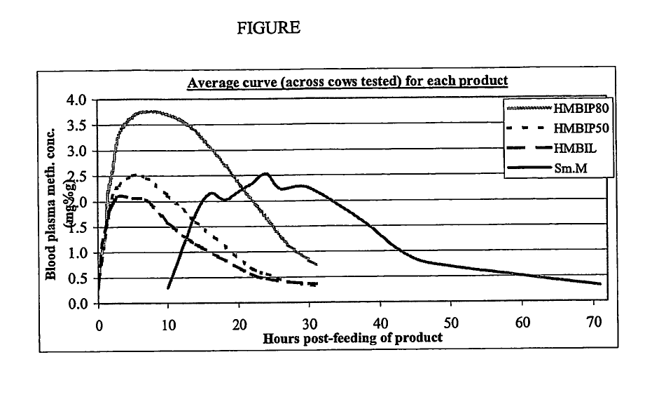

The results are plotted in FIG. 1 which represents the blood plasma methionine concentrations of dairy cows fed various methionine-supplying feed supplements, and where:
HMBIP80 is solid HMBI fed at a dose providing 80 g methionine-equivalent (or HMB) per cow per day (“P” stands for powder)
HMBIP50 is solid HMBI fed at a dose providing 50 g methionine-equivalent (HMB) per cow per day
HMBIL is liquid HMBI fed at a dose providing 50 g methionine-equivalent (HMB) per cow per day (L=liquid)
Sm.M is Smartamine M, fed at a dose providing 50 g methionine per cow per day.

1. An animal rumen-resistant feed supplement in the solid form, said feed supplement comprising at least one methionine derivative and a porous carrier material wherein said methionine derivative is selected from the group consisting of liquid and solid esters of the 2-hydroxy-4-(methylthio)butanoic acid, with the proviso that solid esters have a melting point of 100° C. at most; the 2-amino-4-methylthiobutanamide and the 2-hydroxy-4-methylthiobutanamide, said methionine derivative accounts for at least 20% and up to 70% by weight of the feed supplement and said supplement is in the form of particles having a size range of from 80 to 600 microns.

2. The feed supplement of claim 1, wherein said methionine derivative is a linear or branched alkyl ester of the 2-hydroxy-4-(methylthio)butanoic acid selected from methyl ester, ethyl ester, n-propyl ester, isopropyl ester, butyl esters, namely n-butyl ester, sec butyl ester, isobutyl ester and tertio butyl ester, pentyl esters and hexyl esters, especially n-pentyl, isopentyl, n-hexyl and isohexyl esters.

3. The feed supplement of claim 2, wherein the ester is the isopropyl ester or the tertio butyl ester.

4. The feed supplement as claimed in claim 1, wherein the porous carrier material has a porosity of at least 0.4 ml/g, and preferably at least 1.5 ml/g.

5. The feed supplement as claimed in claim 1, wherein the carrier material is selected from natural clays and silicates such as vermiculite, sepiolite, perlite, bentonite; from zeolithes or from porous silica.

6. The feed supplement of claim 5, wherein the carrier material is sepiolite and the methionine derivative accounts for up to 40% by weight of the feed supplement.

7. The feed supplement of claim 5, wherein the carrier material is silica and the methionine derivative accounts for up to 70% by weight of the feed supplement.

8. The feed supplement as claimed in claim 1, wherein the particles have a size range of from 125 to 500 microns, preferably from 160 to 400 microns.

9. An animal feed comprising a feed supplement as claimed claim 1.
